(19) United States
(12) Patent Application Publication
(10) Pub. No.: US 2023/0385425 A1
(43) Pub. Date: Nov. 30, 2023

(54) DATA GENERATION DEVICE, DATA GENERATION METHOD, AND NON-TRANSITORY STORAGE MEDIUM

(71) Applicant: JVCKENWOOD Corporation, Yokohama-shi (JP)

(72) Inventors: Ako Suzuki, Yokohama-shi (JP); Bo Wang, Yokohama-shi (JP)

(21) Appl. No.: 18/360,863

(22) Filed: Jul. 28, 2023

Related U.S. Application Data
(63) Continuation of application No. PCT/JP2022/003695, filed on Jan. 31, 2022.

(30) Foreign Application Priority Data
Feb. 1, 2021 (JP) 2021-014516

(51) Int. Cl. G06F 21/57; G06F 21/55

(52) U.S. Cl. CPC G06F 21/577; G06F 21/554

(57) ABSTRACT

A data generation device includes a test data group generating unit configured to generate a test data group for testing an operation of a communication device which performs communication by sending and receiving a data group according to a communication protocol, and a state determining unit configured to determine a state of the communication device after the communication device has received the test data group, wherein the test data group generating unit is further configured to generate a next test data group for testing the operation of the communication device based on a determination result about the state of the communication device.

### CROSS-REFERENCE TO RELATED APPLICATIONS

This application is a Continuation of PCT International Application No. PCT/JP2022/003695 filed on Jan. 31, 2022 which claims the benefit of priority from Japanese Patent Application No. 2021-014516 filed on Feb. 1, 2021, the entire contents of both of which are incorporated herein by reference.

### FIELD OF THE INVENTION

The present invention relates to a data generation device, a data generation method, and a non-transitory storage medium.

### BACKGROUND OF THE INVENTION

As a test for detecting a vulnerability of devices and software, sometimes a test method called fuzzing is implemented. During fuzzing, a test data group is input to a detection target, and an operation of the detection target for that input is confirmed. For example, in Japanese Patent Application Laid-open No. 2020-107284, it is disclosed that data included in a normal data group, by which the detection target can perform normal an operation, is substituted with different test data, and a test data group is generated.

When fuzzing is to be performed for a communication device serving as the detection target, a test data group is sent to the communication device and an operation of the communication device are monitored. The communication device performs communication by sending and receiving data groups according to a communication protocol. In order to perform fuzzing appropriately for a communication device that receives data groups according to a communication protocol, the test data group needs to be generated appropriately.

### SUMMARY OF THE INVENTION

A data generation device, a data generation method, and a non-transitory storage medium are disclosed.

According to one aspect of the present application, there is provided a data generation device comprising: a test data group generating unit configured to generate a test data group for testing an operation of a communication device which performs communication by sending and receiving a data group according to a communication protocol; and a state determining unit configured to determine a state of the communication device when the communication device has received the test data group, wherein the test data group generating unit is further configured to generate a next test data group for testing the operation of the communication device based on a determination result about the state of the communication device.

According to one aspect of the present application, there is provided a data generation method comprising: generating a test data group for testing an operation of a communication device which performs communication by sending and receiving a data group according to a communication protocol; determining a state of the communication device after the communication device has received the test data group; and generating a next test data group for testing the operation of the communication device based on a determination result about the state of the communication device.

According to one aspect of the present application, there is provided a non-transitory storage medium that stores a computer program that causes a computer to execute: generating a test data group for testing an operation of a communication device which performs communication by sending and receiving a data group according to a communication protocol; determining a state of the communication device after the communication device has received the test data group; and generating a next test data group for testing the operation of the communication device based on a determination result about the state of the communication device.

The above and other objects, features, advantages and technical and industrial significance of this application will be better understood by reading the following detailed description of presently preferred embodiments of the application, when considered in connection with the accompanying drawings.

### BRIEF DESCRIPTION OF THE DRAWINGS

FIG. 1 is a schematic diagram of a data generation system according to a present embodiment;

FIG. 2 is a schematic block diagram of a communication device according to the present embodiment;

FIG. 3 is a schematic diagram illustrating an exemplary data structure of a data group received by the communication device;

FIG. 4 is a schematic block diagram of a monitoring device according to the present embodiment;

FIG. 5 is a schematic block diagram of a data generation device according to the present embodiment;

FIG. 6 is a flowchart for explaining a flow of a fuzzing processes;

FIG. 7 is a schematic diagram for explaining an example of a generation of a test data group according to a proximity substitution process; and

FIG. 8 is a schematic diagram for explaining an example of a generation of a test data group according to a random substitution process.

### DETAILED DESCRIPTION OF THE INVENTION

An exemplary embodiment is escribed below in detail with reference to the accompanying drawings. However, the present application is not limited by the embodiments described below.

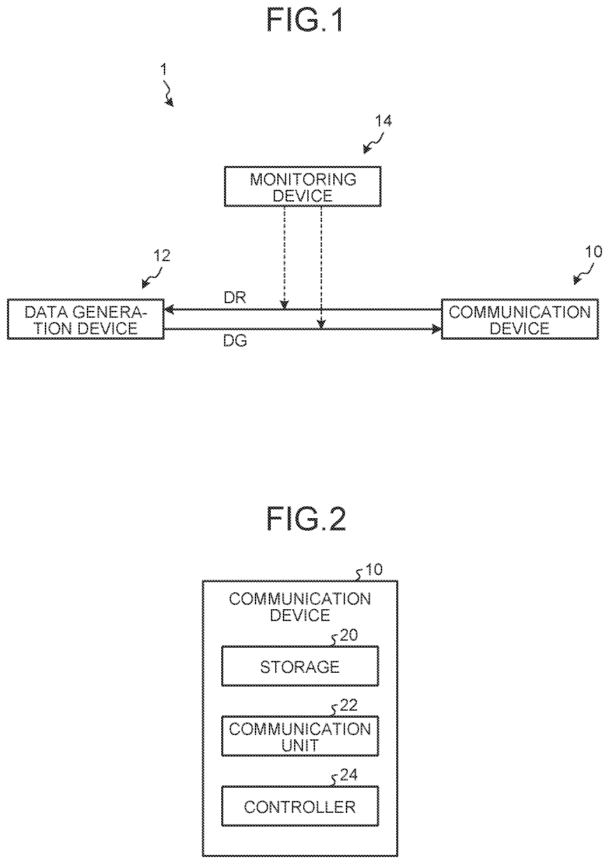

FIG. 1 is a schematic diagram of a data generation system according to the present embodiment. A fuzzing system 1 according to the present embodiment performs real-time fuzzing for a communication device 10. Herein, fuzzing represents a test method in which a test data group is input to a test target (herein, the communication device 10), an operation of the test target for that input is confirmed, and a vulnerability of the test target is confirmed.

Communication Device

The communication device 10 is capable of communicating with other devices for sending and receiving information. In the present embodiment, the communication device 10 sends and receives information according to wireless communication. More particularly, the communication device 10 performs wireless communication based on Bluetooth (registered trademark). However, the communication method implemented in the communication device 10 is not limited to Bluetooth. Alternatively, wireless communication according to any arbitrary method can be performed, or wired communication can be performed.

FIG. 2 is a schematic block diagram of the communication device according to the present embodiment. As illustrated in FIG. 2, the communication device 10 includes a storage 20, a communication unit 22, and a controller 24. The storage 20 is used to store a variety of information such as arithmetic processing details of the controller 24 and computer programs, and includes at least either a main memory device, such as a random access memory (RAM) or a read only memory (ROM), or an external memory device such as a hard disk drive (HDD). Computer programs that are stored in the storage 20 and that are to be executed by the controller 24 can be stored in a recording medium readable by the communication device 10. The communication unit 22 represents a communication module. The controller 24 is an arithmetic device, that is, a central processing unit (CPU). The controller 24 reads the computer programs (software) stored in the storage 20, executes them, and implements various operations such as communication. Meanwhile, the communication device 10 can include an input unit that receives input of a user, and an output unit that outputs information.

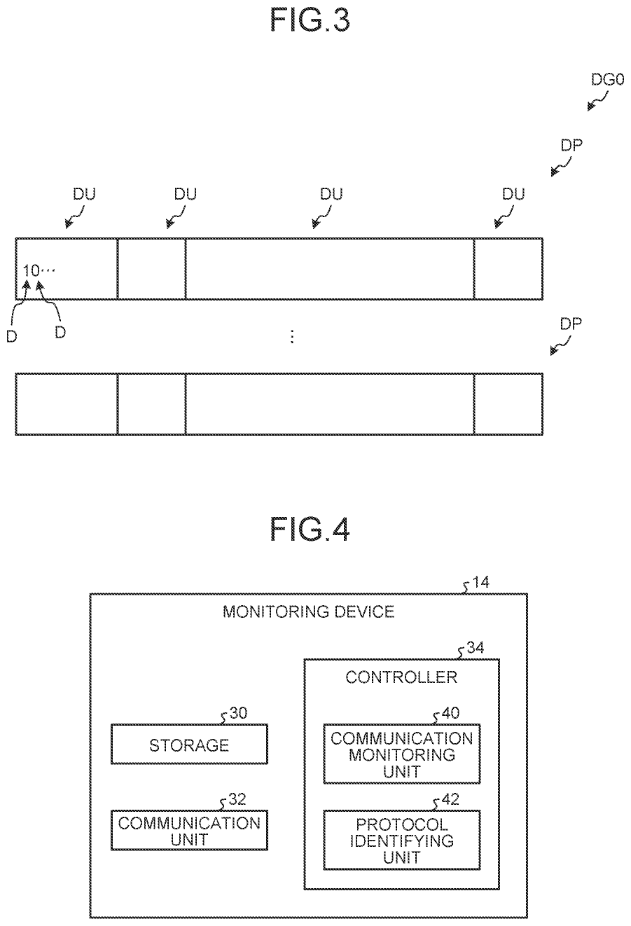

FIG. 3 is a schematic diagram illustrating an exemplary data structure of a data group received by the communication device. The communication device 10 communicates with other devices by sending and receiving data groups according to a communication protocol. As illustrated in FIG. 3, a data group DG0 that is received by the communication device 10 during the communication is a data group (a data block) having multiple pieces of data D arranged therein. In the example illustrated in FIG. 3, the data D represents binary data made of numerical values of 0 and 1. However, the data D are not limited to be binary data. Alternatively, the data D can be numerical data made of a numerical value from 0 to 9, or can be character data made of a character from a to z, for example. Thus, the data D can be of at least one type from among character data, numerical data, and binary data. That is, the data group DG0 can be configured to include at least one combination among character data, numerical data, and binary data.

The data group DG0 is divided into multiple packets DP, and then the packets DP are sent and received. That is, the communication device 10 sequentially receives multiple packets DP, combines the packets DP and rebuilds information included in the data group DG0, and performs communication-related processing. Each packet DP is further divided into multiple data units DU, and each data units DU includes multibit data D. In each packet DP, the data units DU contain mutually different information. For example, a single packet DP includes a data unit DU indicating a source address, a data unit DU indicating a delivery address, and a data unit DU related to processing details. In this way, the data group DG0 that is received by the communication device 10 during communication is divided into multiple packets DP. However, that is not the only possible case. Alternatively, a single packet DP can be treated as a single data group DG0.

Fuzzing System

The fuzzing system 1 according to the present embodiment substitutes at least some of pieces of data D, which are included in the data group DG0 according to a communication protocol, with different pieces of data that are different from the original pieces of data D, and generates a test data group DG that is to be used in testing an operation of the communication device 10. In other words, the test data group DG represents a data group in which at least some of pieces of data D of the data group DG0 (a normal data group), by which the communication device 10 can perform a normal operation, are substituted with different pieces of data. Then, the fuzzing system 1 sends the test data group DG to the communication device Depending on the test data group DG, there are cases in which the communication device 10 performs a normal operation and in which the communication device 10 does not perform a normal operation. Herein, performing a normal operation means exhibiting the same behavior as the behavior when the data group DG0 is input. On the other hand, not performing a normal operation means, for example, exhibiting a different behavior from the behavior when the data group DG0 is input, and means that the operation details are not normal. In the example given in the present embodiment, when performing a normal operation, the communication device 10 sends a response data group DR to the fuzzing system 1. Details of the response data group DR correspond to details of the data group DG0. Moreover, in the present embodiment, when not performing a normal operation, the communication device 10 does not send the response data group DR to the fuzzing system 1. In these cases, when the response data group DR is received, the fuzzing system 1 determines that the communication device performed a normal operation, and when the response data group DR is not received, the fuzzing system 1 determines that the communication device 10 did not perform a normal operation (i.e., when malfunctioning occurred).

Herein, the communication device 10 performs an operation (sends and receives data groups) according to a communication sequence to thereby communicate with other devices. Moreover, the communication is performed according to a stateful method. Hence, for each communication sequence, the communication device 10 performs communication according to a different communication protocol. If the communication protocol is different, then a data structure of the data group DG0 changes. Thus, in a case of performing real-time fuzzing for the communication device 10, since the data structure of the data group DG0 changes according to the communication sequence, there is a risk that the test data group DG cannot be appropriately generated. In contrast, in the fuzzing system 1 according to the present embodiment, the test data group DG can be appropriately generated by performing at least one of following operations (explained later): an operation in which the next test data group DG is generated based on a response of the communication device 10 to an input of the previous test data group DG; an operation in which the communication protocol is analyzed and data D to be substituted is selected; and an operation in which the next test data group DG is generated using a genetic algorithm. As a result, real-time fuzzing can be appropriate performed. Given below is an explanation of a configuration of the fuzzing system 1.

As illustrated in FIG. 1, the fuzzing system 1 according to the present embodiment includes a data generation device 12 and a monitoring device 14. The data generation device 12 generates the test data group DG, sends the generated test data group DG to the communication device 10, and receives a response data group DR from the communication device 10. That is, the data generation device 12 performs fuzzing. Regarding the data generation device 12, the details are explained later.

Monitoring Device 14

The monitoring device 14 detects the data groups sent and received between the communication device 10 and the data generation device 12. The monitoring device 14 analyzes the data groups sent and received between the communication device 10 and the data generation device 12, and identifies the communication protocol that is being used.

FIG. 4 is a schematic block diagram of the monitoring device according to the present embodiment. As illustrated in FIG. 4, the monitoring device 14 includes a storage 30, a communication unit 32, and a controller 34. The storage 30 is used to store a variety of information such as arithmetic processing details of the controller 34 and computer programs, and includes at least either a main memory device, such as a RAM or a ROM, or an external memory device such as an HDD. The computer programs that are stored in the storage 30 and that are to be executed by the controller 34 can be stored in a recording medium readable by the monitoring device 14. The communication unit 32 represents a communication module. Meanwhile, the monitoring device 14 can include an input unit that receives input of a user, and an output unit that outputs information.

The controller 34 is an arithmetic device, that is, a CPU. The controller 34 includes a communication monitoring unit 40 and a protocol identifying unit 42. The controller 34 reads the computer programs (software) stored in the storage 30, executes them, and implements the communication monitoring unit 40 and the protocol identifying unit 42 to perform their respective processes. Meanwhile, the controller 34 either can perform such processes using a single CPU, or can include multiple CPUs and perform the processes using those CPUs. Alternatively, at least either the communication monitoring unit 40 or the protocol identifying unit 42 can be implemented using hardware.

The communication monitoring unit 40 causes the communication unit 32 to receive the data groups sent and received between the communication device 10 and the data generation device 12, and thus acquires the data groups sent and received between the communication device 10 and the data generation device 12. For example, the communication monitoring unit 40 acquires the data groups sent from the data generation device 12 to the communication device 10, as well as acquires the data groups sent from the communication device 10 to the data generation device 12. Alternatively, the communication monitoring unit 40 can receive the data groups sent at least in one direction.

The protocol identifying unit 42 analyzes the data group acquired by the communication monitoring unit 40, and identifies the communication protocol used for communication between the communication device 10 and the data generation device 12. The protocol identifying unit 42 can identify the communication protocol according to an arbitrary method. For example, when the information indicating the communication protocol is included in the data group, then the communication protocol can be identified by reading that information.

The protocol identifying unit 42 identifies substitutable data based on the identified communication protocol. The substitutable data represents data D which can be substituted for a purpose of generating the test data group DG. A data group sent from the data generation device 12 to the communication device 10 includes data D which, upon substitution, make the data group unreachable to the destination (the communication device 10), and includes data D which, even upon substitution, still make the data group reachable to the destination. Thus, based on the data structure of the data group according to the identified communication protocol, the protocol identifying unit 42 identifies data D which, even upon substitution, make the data group reachable to the destination (the communication device 10), and treats the identified data D as the substitutable data. In other words, the protocol identifying unit 42 does not treat, as the substitutable data, data D which, upon substitution, make the data group unreachable to the destination (the communication device 10). For example, the protocol identifying unit 42 can treat, as the substitutable data, data D which is not included in the data units DU indicating the source address and the destination address. More particularly, the protocol identifying unit 42 can treat, as the substitutable data, data which is included in the data units DU indicating headers, locations, and contents.

The protocol identifying unit 42 sends the information on the identified substitutable data to the data generation device 12 via the communication unit 32.

Data Generation Device

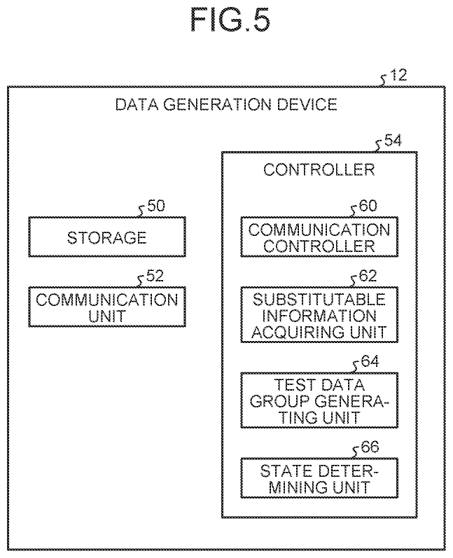

FIG. 5 is a schematic block diagram of the data generation device according to the present embodiment. As illustrated in FIG. 5, the data generation device 12 includes a storage 50, a communication unit 52, and a controller 54. The storage 50 is used to store a variety of information such as arithmetic processing details of the controller 54 and computer programs, and includes at least either a main memory device, such as a RAM or a ROM, or an external memory device such as an HDD. The computer programs that are stored in the storage 50 and that are to be executed by the controller 54 can be stored in a recording medium readable by the data generation device 12. The communication unit 52 represents a communication module. Meanwhile, the data generation device 12 can include an input unit that receives input of a user, and an output unit that outputs information.

The controller 54 is an arithmetic device, that is, a CPU. The controller 54 includes a communication controller a substitutable information acquiring unit 62, a test data group generating unit 64, and a state determining unit 66. The controller 54 reads the computer programs (software) stored in the storage 50, executes them, and implements the communication controller 60, the substitutable information acquiring unit 62, the test data group generating unit 64, and the state determining unit 66 to perform their respective processes. Meanwhile, the controller 54 either can perform such processes using a single CPU, or can include multiple CPUs and perform the processes using those CPUs. Alternatively, at least some of the communication controller 60, the substitutable information acquiring unit 62, the test data group generating unit 64, and the state determining unit 66 can be implemented using hardware.

The communication controller 60 communicates with external devices via the communication unit 52 for sending and receiving information. The communication controller 60 sends the test data group DG to the communication device 10. The communication controller 60 acquires the response data group DR from the communication device 10. Regarding the specific processes performed by the communication controller 60, the explanation is given later.

The substitutable information acquiring unit 62 acquires information on the substitutable data (i.e., the data that can be substituted for the purpose of generating the test data group DG) identified based on the communication protocol. The substitutable information acquiring unit 62 can acquire, as the information on the substitutable data, the addresses of the substitutable data in a data group. In the present embodiment, the substitutable information acquiring unit 62 acquires the information on the substitutable data from the monitoring device 14 via communication. However, that is not the only possible case. Alternatively, the substitutable information acquiring unit 62 can identify the substitutable data by itself based on the communication protocol, and can acquire the information on the substitutable data. That is, the substitutable information acquiring unit 62 can be equipped with a function of the protocol identifying unit 42 of the monitoring device 14.

The test data group generating unit 64 generates the test data group DG. Regarding the specific processes performed by the test data group generating unit 64, the explanation is given later.

The state determining unit 66 determines a state of the communication device 10 after the communication device 10 has received the test data group DG. That is, the state determining unit 66 determines whether or not the communication device 10, which received the test data group DG, performed normal operations. Regarding the specific processes performed by the state determining unit 66, the explanation is given later. The state determining unit 66 either can output that determination result or can display it in, for example, the display of the data generation device 12.

Processes Performed by Data Generation Device

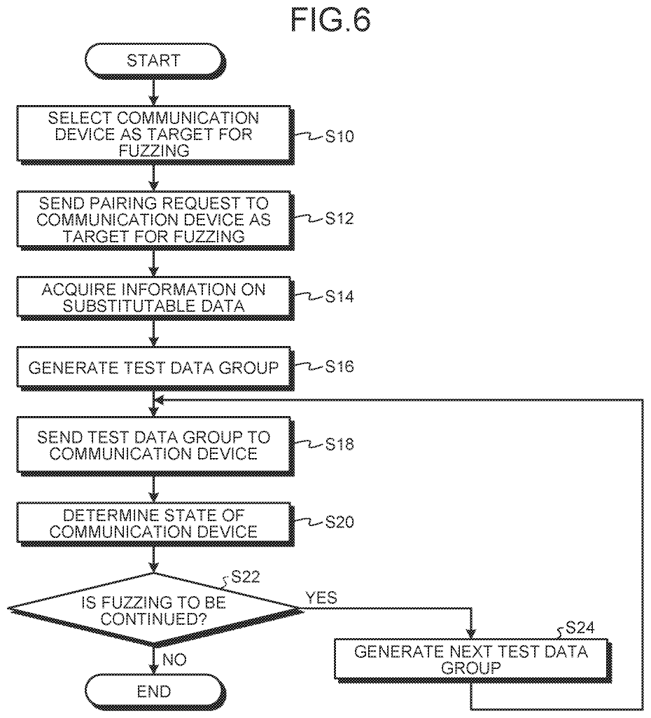

Given below is a flow of a fuzzing process performed by the data generation device 12. FIG. 6 is a flowchart for explaining a flow of the fuzzing process. As illustrated in FIG. 6, the data generation device 12 selects a communication device 10 as a target for fuzzing (Step S10). In the present embodiment, the data generation device 12 scans peripheral devices and selects a communication device 10 as a target for fuzzing. Then, in the data generation device 12, the communication controller 60 sends a pairing request to the communication device 10 as a target for fuzzing (Step S12). In other words, the communication controller 60 sends, to the communication device 10, a data group that includes the information indicating a pairing request. The communication device 10 accepts the pairing request. Accordingly, the communication device 10 and the data generation device 12 become able to send and receive data groups according to the communication protocol for the communication sequence.

Then, in the data generation device 12, the substitutable information acquiring unit 62 acquires the information on the substitutable data (Step S14). In the present embodiment, the communication monitoring unit 40 of the monitoring device 14 acquires the data groups that were recently sent and received between the communication device 10 and the data generation device 12, and the protocol identifying unit 42 of the monitoring device 14 analyzes the data groups, identifies the communication protocol, and identifies the substitutable data based on the communication protocol. Then, from the monitoring device 14, the substitutable information acquiring unit 62 of the data generation device 12 acquires the information on the substitutable data identified by the protocol identifying unit 42.

Subsequently, in the data generation device 12, the test data group generating unit 64 generates the test data group DG (Step S16). The test data group generating unit 64 acquires the data group DG0 (i.e., a normal data group that enables the communication device 10 to perform a normal operation) according to the communication protocol in the current communication sequence, substitutes a part of data D of the data group DG0 with other data, and generates the test data group DG. In the present embodiment, based on the information on the substitutable data acquired by the substitutable information acquiring unit 62, the test data group generating unit 64 generates the test data group DG. More particularly, the test data group generating unit 64 substitutes, from among the data D included in the data group DG0, data D which is identified as the substitutable data (data positioned at the same address as the address of the substitutable data) with other data, and generates the test data group DG. When multiple pieces of the substitutable data is present, the test data group generating unit 64 either can substitute all of the pieces of data identified as the substitutable data, or can substitute only some of the pieces of data identified as the substitutable data.

In the data generation device 12, once the test data group DG is generated, the communication controller 60 sends the test data group DG to the communication device 10 as a target for fuzzing (Step S18). Upon receiving the test data group DG, the communication device 10 performs an operation according to the test data group DG. As explained above, in the present embodiment, when the data group DG0 (a normal data group) according to the communication protocol in the current communication sequence is received, the communication device 10 sends the response data group DR. Thus, upon receiving the test data group DG, if the communication device 10 performs a normal operation, it sends the response data group DR to the data generation device 12. However, if the communication device 10 does not perform a normal operation, it does not send the response data group DR.

In the data generation device 12, the state determining unit 66 determines the state of the communication device 10 after the communication device 10 has received the test data group DG (Step S20). In the present embodiment, if the data generation device 12 receives the response data group DR from the communication device 10, then the state determining unit 66 determines that the state of the communication device 10 indicates a normal operation. On the other hand, if the data generation device 12 does not receive the response data group DR from the communication device 10, then the state determining unit 66 determines that the state of the communication device 10 does not indicate a normal operations.

In this way, in the present embodiment, based on the presence or absence of the response data group DR, the state determining unit 66 determines the state of the communication device 10 after the communication device 10 has received the test data group DG. However, that is not the only possible method for determining the state of the communication device 10. Alternatively, for example, if an abnormal data group different from the response data group DR is received from the communication device 10 or if an error signal indicating that a normal operation is not performed is received from the communication device 10, then the state determining unit 66 can determine that the communication device 10 is not performing a normal operation. Still alternatively, for example, a device for monitoring the state of the communication device 10 can be installed in advance, and that device can send information indicating the state of the communication device 10 to the data generation device 12. In that case, based on the received information indicating the state of the communication device 10, the state determining unit 66 determines the state of the communication device 10.

Subsequently, if the fuzzing is not to be continued (No at Step S22), then the fuzzing process is ended. On the other hand, if the fuzzing is to be continued (Yes at Step S22), then the test data group generating unit 64 of the data generation device 12 generates the next test data group DG (Step S24). Then, the system control returns to Step S18, and the communication controller 60 sends the next test data group DG to the communication device 10. Until it is determined at Step S22 that the fuzzing is not to be continued, the data generation device 12 repeatedly updates the test data group DG and performs the fuzzing process. Meanwhile, the determination about whether or not to continue the fuzzing process can be performed in an arbitrary manner. For example, if the state of the communication device 10 is determined to be normal, then it can be determined to continue with the fuzzing. However, if the state of the communication device 10 is determined not to be normal, then it can be determined to end the fuzzing.

Given below is an explanation of the details of a generation operation performed at Step S24 for generating the next test data group DG.

The test data group generating unit 64 substitutes at least a part of data D, which is included in the most-recently generated test data group DG, with other data, and generates the next test data group DG. That is, the next test data group DG can be said to be a data group by substituting at least a part of data D, which is included in the most-recently generated test data group DG, with other data.

The test data group generating unit 64 can generate the next test data group DG based on the information on the substitutable data. That is, the test data group generating unit 64 substitutes, from among the data included in the most recent test data group DG, data D which is identified as the substitutable data (data positioned at the same address as the address of the substitutable data) with other data, and generates the next test data group DG. When multiple pieces of the substitutable data is present, the test data group generating unit 64 either can substitute all of the pieces of data identified as the substitutable data, or can substitute only some of the pieces of data identified as the substitutable data. Meanwhile, in the present embodiment, every time the test data group DG is sent to the communication device 10, the substitutable data gets updated. That is, every time the test data group DG is to be sent to the communication device 10, the monitoring device 14 receives and analyzes the test data group DG, identifies the communication protocol, and identifies substitutable data based on the communication protocol. Then, using the substitutable data identified based on the most recent test data group DG, the test data group generating unit 64 generates the next test data group DG. However, there is no restriction that the substitutable data has to be updated. Alternatively, the test data group generating unit 64 can generate the subsequent test data group DG based on the information on the substitutable data acquired at Step S14, that is, based on the information on the substitutable data used in generating the first test data DG.

In the following explanation too, unless specified otherwise, it is desirable that, from among the data identified as the substitutable data (i.e., from among the data positioned at the same address as the address of the substitutable data), the test data group generating unit 64 selects the data that is to be substituted with other data, and generates the next test data group DG.

Meanwhile, the test data group generating unit 64 can generate the next text data group DG also based on the determination result by the state determining unit 66 about the state of the communication device 10. That is, based on the state of the communication device 10 after the communication device 10 has received the most recent test data group DG, the test data group generating unit 64 generates the next test data group DG. For example, depending on whether the communication device 10 performed a normal operation or did not perform a normal operation, the test data group generating unit 64 can generate the next test data group DG according to a different method. For example, if the communication device 10 did not perform a normal operation, then, the test data group generating unit 64 can substitute data D present within a predetermined range in the substituted data in the most recent test data group DG with other data. As a result, a relevant error at an addresses close to the data by which an error has occurred can be detected appropriately. Alternatively, if the communication device 10 did not perform a normal operation, then, in the data substituted at a time of generating the most recent test data group DG, the test data group generating unit 64 can substitute data D which is present outside a predetermined range in the most recent test data group DG with other data. As a result, error detection can be performed over a wide range. Herein, the predetermined range indicates that, in the test data group DG, the addresses are within a predetermined range. For example, in a cluster analysis in data science, if the Euclidean distance is equal to or shorter than a predetermined distance, then the addresses can be said to be present within a predetermined range. Alternatively, if a hamming distance in a code theory is equal to or shorter than a predetermined distance, then the addresses can be said to be present within a predetermined range. On the other hand, for example, if the test data group DG is sent by dividing it into multiple packets of DP, data D included in another packet DP can be treated to have the addresses outside a predetermined range.

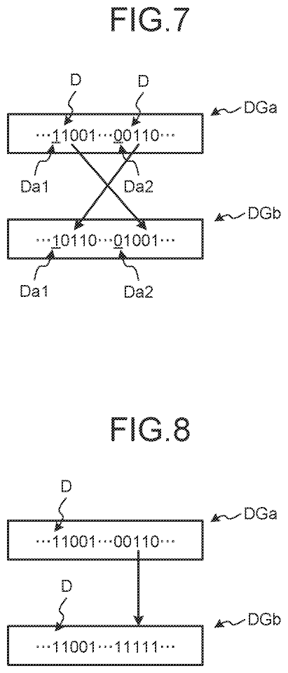

Based on the data structure of the most recent test data group DG, the test data group generating unit 64 can generate the next test data group DG. For example, the test data group generating unit 64 can generate the test data group DG using a genetic algorithm. More particularly, the test data group generating unit 64 can generate the next test data group DG according to a proximity substitution process. FIG. 7 is a schematic diagram for explaining an example of generation of a test data group according to a proximity substitution process. In the proximity substitution process, data D present within a predetermined range in the substituted data in the most recent test data group DG is substituted with other data, and the next test data group DG is generated. In the proximity substitution process, as illustrated in FIG. 7, the next test data group TG can be generated based on a partial crossover. Herein, a partial crossover implies that two types of genetic sequences are combined at a fixed probability, and a new type of genetic sequence is formed. At the time of generating the test data group DG, the partial crossover implies that, positions (addresses) are interchanged between pieces of data D present at different positions (addresses) in the most recent test data group DG, and the next test data group DG is generated. In FIG. 7, a test data group DGa represents the most recent test data group DG, and a test data group DGb represents the test data group DG to be generated next. In that case, in the example illustrated in FIG. 7, the data D present within a predetermined range (in the example illustrated in FIG. 7, “1001”) in the data Da1 that was substituted at the time of generating the test data group DGa is interchanged with the data D present within a predetermined range in the data Da2 that was substituted at the time of generating the test data group DGa (in the example illustrated in FIG. 7, interchanged with “0110”), and the test data group DGb is generated.

Herein, it is desirable that the data generation device 12 repeatedly performs a generation process in which the test data group DG is generated according to the proximity substitution operation and an operation in which the test data group DG is sent to the communication device and the state of the communication device 10 is determined. Then, the test data group generating unit 64 determines whether the proximity-substitution-operation-based evaluation (determination result) for the state of the communication device 10 which has received the test data group DG has converged. If the evaluation has not converged, then the test data group generating unit 64 repeats the proximity substitution operation again. When the evaluation converges, then the test data group generating unit 64 performs a random substitution process. In the random substitution process, from among the data D included in the most recent test data group DG, data to be substituted is randomly selected and is substituted with other data, and the next test data group DG is generated. Meanwhile, in the proximity substitution process, whether the evaluation has converged can be determined according to an arbitrary determination method. For example, if a number of times by which the state of the communication device 10 which receives the test data group DG by the proximity substitution process is determined to be normal is equal to or greater than a predetermined count, then it can be determined that the evaluation has converged in the proximity substitution process. Alternatively, for example, using a method based on K-means, a similarity among the test data groups DG can be analyzed, and if an in-cluster data density of the test data group DG generated in the proximity substitution process exceeds a predetermined threshold value, then it can be determined that the evaluation has converged. Still alternatively, for example, in a case of using machine learning, from a distance between the substituted pieces of data and from data values, a gradient angle and a gradient extreme can be calculated according to a gradient method or the Newton method, and, if the calculated value exceeds a predetermined threshold value, then it can be determined that the evaluation has converged.

FIG. 8 is a schematic diagram for explaining an example of generation of a test data group according to the random substitution operation. In the random substitution operation, as illustrated in the example in FIG. 8, the next test data group DGb can be generated according to a mutation. Herein, a mutation indicates that particular bits in a genetic sequence are reversed at a fixed probability, so that the genetic sequence becomes of a different type. At the time of generating the test data group DG, as illustrated in the example in FIG. 8, a mutation indicates a process in which the data D in the most recent test data group DGa is randomly substituted, and the next test data group DGb is generated.

Meanwhile, the test data group generating unit 64 is not limited to use the partial crossover in the proximity substitution process, and is not limited to use the mutation in the random substation operation. Thus, it can be said the test data group generating unit 64 need not use a genetic algorithm.

As explained above, the data generation device 12 according to the present embodiment includes the test data group generating unit 64 and the state determining unit 66. The test data group generating unit 64 generates the test data group DG to be used in testing the processes of the communication device 10 that performs communication by sending and receiving data groups according to a communication protocol. The state determining unit 66 determines the state of the communication device 10 after the communication device 10 has received the test data group DG. Based on the determination result for the state of the communication device 10, the test data group generating unit 64 generates the next data group DG to be used in testing the processes of the communication device 10. When performing fuzzing for the communication device 10 that receives data groups according to the communication protocol, the test data group DG needs to generated appropriately. In this regard, according to the present embodiment, based on the operation state of the communication device 10 for the previous test data group DG, the data generation device 12 generates the next test data group DG. Hence, according to the response of the communication device 10, the test data group DG for fuzzing can be generated appropriately. More particularly, since the communication device 10 sends and receives data groups according to the communication sequence, the data structure of the data groups changes according to the communication sequence. In this regard, based on the operation state of the communication device 10 for the previous test data group DG, the data generation device 12 generates the next test data group DG. Hence, an appropriate test data group DG can be generated according to the communication sequence, and real-time fuzzing can be performed appropriately.

Moreover, the test data group generating unit 64 substitutes at least a part of data D in the previous test data group DG with other data, and generates the next test data group DG. Since the data generation device 12 generates the next test data group DG by substituting a part of data, an appropriate test data group DG can be generated according to the communication sequence, and real-time fuzzing can be performed appropriately.

Furthermore, the test data group generating unit 64 performs the proximity substitution process in which, data present within a predetermined range in the substituted data in the most recent test data group DG is selected as data to be substituted, and substitutes the data to be substituted with other data selected from among the most recent test data group DG, and generates the next test data group DG. As a result of performing the proximity substitution process, the data generation device 12 can \ detect related errors appropriately.

Moreover, when the proximity substitution process is repeatedly performed and when the determination for the state of the communication device 10 in response to receiving each test data group DG generated in the proximity substitution operation has converged, the test data group generating unit 64 randomly selects, from among the data included in the most recent test data group DG, the data to be substituted, and generates the next test data group. Once the determination in the proximity substitution process has converged, the data generation device 12 switches to the random substitution process and thus becomes able to detect unpredicted errors appropriately.

Moreover, the test data group generating unit 64 uses a genetic algorithm to generate the next test data group DG. As a result of using the genetic algorithm, the data generation device 12 becomes able to generate an appropriate test data group DG in accordance with the communication sequence, and to perform real-time fuzzing appropriately.

The data generation device 12 further includes the substitutable information acquiring unit 62 that acquires the information on the substitutable data identified based on the communication protocol. Based on the information on the substitutable data, the test data group generating unit 64 substitutes the data included in the data group DG0 that enables the communication device 10 to perform a normal operation, and generates the test data group DG. The data structure of the data groups received by the communication device 10 changes according to the communication sequence. Thus, it is difficult to know in advance about which data is to be substituted for generating the test data group DG. For example, if the data to be substituted is selected in a random manner, then there is a risk that, for example, data indicating the addresses of the source and the destination are substituted and the test data group DG cannot be delivered to the communication device 10. In this regard, the data generation device 12 acquires the information on the substitutable data that is identified based on the communication protocol, and accordingly selects the data to be substituted. Hence, even when the data structure changes according to the communication sequence, an appropriate test data group DG can be generated in real time.

The data generation device 12 further includes the communication controller 60 that sends the test data group DG to the communication device 10, and receives the response data group DR which is sent by the communication device 10 after the communication device 10 has received the test data group DG. In the data generation device 12, since the communication controller 60 sends and receives data groups, the fuzzing of the communication device 10 can be performed appropriately.

Meanwhile, in the present embodiment, the fuzzing system 1 includes two hardware components, that is, the monitoring device 14 that identifies the communication protocol and the data generation device 12 that performs fuzzing. However, that is not the only possible case, and there can be an arbitrary number of hardware components for implementing the functions of the fuzzing system 1. For example, the data generation device 12 can be equipped with the function of the monitoring device 14, so that the fuzzing system 1 can be implemented using a single hardware component. Alternatively, for example, the function of the data generation device 12 can be implemented using multiple hardware components. In that case, for example, a data generation device that generates the test data group DG and a fuzzing execution device that sends the generated test data group DG to the communication device 10 and performs fuzzing can be provided.

According to the present embodiment, when fuzzing is to be performed for a communication device as a detection target, test data groups can be generated appropriately.

Although the application has been described with respect to specific embodiments for a complete and clear application, the appended claims are not to be thus limited but are to be construed as embodying all modifications and alternative constructions that may occur to one skilled in the art that fairly fall within the basic teaching herein set forth.

A data generation device, a data generation method, and a non-transitory storage medium according to the present application can be used for communication.

What is claimed is:

1. A data generation device comprising:
a test data group generating unit configured to generate a test data group for testing an operation of a communication device which performs communication by sending and receiving a data group according to a communication protocol; and
a state determining unit configured to determine a state of the communication device after the communication device has received the test data group, wherein
the test data group generating unit is further configured to generate a next test data group for testing the operation of the communication device based on a determination result about the state of the communication device.

2. The data generation device according to claim 1, wherein the test data group generating unit is further configured to substitute at least a part of data included in a previous test data group with other data to generate the next test data group.

3. The data generation device according to claim 2, wherein the test data group generating unit is further configured to perform a proximity substitution process in which
data present within a predetermined range in the data substituted in a most recent data group is selected as data to be substituted,
the data to be substituted is substituted with other data included in the most recent test data group, and
the next test data group is generated.

4. The data generation device according to claim 3, wherein the test data group generating unit is further configured to:
repeatedly performs the proximity substitution process,
randomly select, when the state of the communication device after the communication device has received each of the test data groups generated in the proximity substitution process has converged, the data to be substituted from among the data included in the previous test data group, and
generate the next test data group.

5. A data generation method comprising:
generating a test data group for testing an operation of a communication device which performs communication by sending and receiving a data group according to a communication protocol;
determining a state of the communication device after the communication device has received the test data group; and
generating a next test data group for testing the operation of the communication device based on a determination result about the state of the communication device.

6. A non-transitory storage medium that stores a computer program that causes a computer to execute:
generating a test data group for testing an operation of a communication device which performs communication by sending and receiving a data group according to a communication protocol;
determining a state of the communication device after the communication device has received the test data group; and
generating a next test data group for testing the operation of the communication device based on a determination result about the state of the communication device.
